(19) United States
(12) Patent Application Publication
(10) Pub. No.: US 2009/0030455 A1
(43) Pub. Date: Jan. 29, 2009

(54) Toy For Retaining Multiple Size Pacifiers

(76) Inventor: Stacy A. Dallman, Lyndonville, NY (US)

Correspondence Address: DONALD J. ERSLER, S.C., 725 GARVENS AVENUE, BROOKFIELD, WI, 53005, US

(21) Appl. No.: 11/782,003

(22) Filed: Jul. 24, 2007

(51) Int. Cl. A61J 17/00

(52) U.S. Cl. 606/236

(57) ABSTRACT

A toy for retaining multiple size pacifiers includes a toy structured to retain at least one button handle pacifier. The toy further includes a retention ring. The retention ring is secured to an outer surface of the toy. Each button handle pacifier includes a nipple portion, a lip shield and a retention knob. The nipple portion extends from one side of the lip shield and the retention knob extends from the other side thereof. A ring groove is formed between the lip shield and one end of the retention knob. The other end of the retention knob is preferably rounded to facilitate insertion into the a knob opening in the retention ring. The size of the nipple portion and lip shield are increased in size to accommodate larger oral cavities of older children. A retention ring may also extend from an outer surface of the toy.

### BACKGROUND OF THE INVENTION

1. Field of the Invention

The present invention relates generally to child pacifiers and more specifically to a toy for retaining multiple size pacifiers for different age children.

2. Discussion of the Prior Art

U.S. Pat. No. 4,188,747 to Kramer discloses an infant pacifier combination. The Kramer patent includes an object or toy, naturally attractive to small children and infants, which is provided with a receptacle at an advantageous location for reception of a nipple serving as a pacifier. The Kramer patent requires a specially designed pacifier and will not retain a prior art pacifier.

U.S. Pat. No. 6,634,919 to Gordon et al. discloses a pacifier toy. The Gordon et al. patent includes a pacifier toy with a pacifier having a rigid plastic plate and an integral resilient, centrally located nipple, a holding ring and a child's toy having an animal shape where the face portion of the animal is framed so that it can receive the pacifier. The Gordon et al. patent retains a ring handled prior art pacifier.

Accordingly, there is a clearly felt need in the art for a toy for retaining multiple size pacifiers for different age children with a button handle prior art pacifier.

### SUMMARY OF THE INVENTION

The present invention provides a toy for retaining multiple size pacifiers for different age children. The toy for retaining multiple size pacifiers (pacifier toy) includes a toy structured to retain at least one button handle pacifier. The toy may be of any shape or design. The toy further includes a retention ring. The retention ring is retained in an outer surface of the toy. The retention ring is preferably elastic to facilitate insertion. Each button handle pacifier includes a nipple portion, a lip shield and a retention knob. The nipple portion is suitable for insertion into a child's mouth for pacification purposes. The nipple portion extends from one side of the lip shield and the retention knob extends from the other side of the lip shield. A ring groove is formed between the lip shield and one end of the retention knob. The other end of the retention knob is preferably rounded to facilitate insertion into the a knob opening formed through the retention ring. The size of the nipple portion and lip shield are increased in size to accommodate the larger oral cavities of older children. It is preferable for a perimeter of the retention knob to remain the same regardless of the size of pacifier. A retention ring may also extend from the body of the toy, instead of being retained in an outer surface of the toy.

Accordingly, it is an object of the present invention to provide a pacifier toy for retaining multiple size button handle pacifiers for different age children.

These and additional objects, advantages, features and benefits of the present invention will become apparent from the following specification.

### BRIEF DESCRIPTION OF THE DRAWINGS

FIG. 1 is a perspective view of a button handle pacifier before insertion into a stuffed dog toy of a pacifier toy in accordance with the present invention.

FIG. 2 is a cross sectional view of a button handle pacifier retained in a portion of a stuffed dog toy of a pacifier toy in accordance with the present invention.

FIG. 3 is a perspective view of a plurality of different size button handle pacifiers adjacent a stuffed dog toy of a pacifier toy in accordance with the present invention.

FIG. 4a is a front view of a guitar toy of a pacifier toy in accordance with the present invention.

FIG. 4b is a side view of a guitar toy with a button handle pacifier inserted therein of a pacifier toy in accordance with the present invention.

FIG. 5a is a front view of a flower toy of a pacifier toy in accordance with the present invention.

FIG. 5b is a side view of a flower toy with a button handle pacifier inserted therein of a pacifier toy in accordance with the present invention.

FIG. 6a is a top view of a stuffed dog toy with a retention ring extending from a front thereof of a pacifier toy in accordance with the present invention.

FIG. 6b is a side view of a stuffed dog toy with a button handle pacifier inserted into a retention ring of a pacifier toy in accordance with the present invention.

### DETAILED DESCRIPTION OF THE PREFERRED EMBODIMENTS

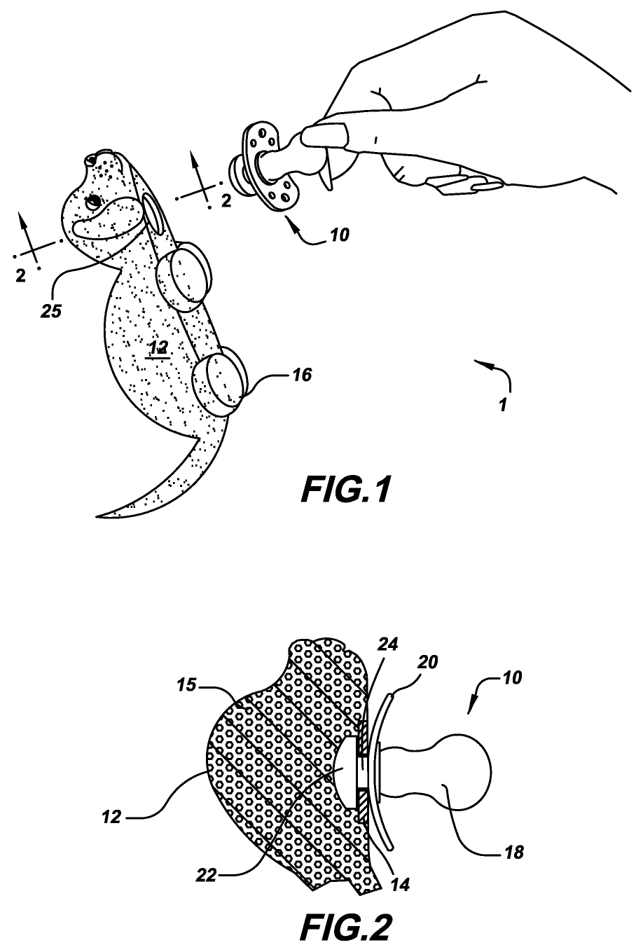

With reference now to the drawings, and particularly to FIG. 1, there is shown a perspective view of a button handle pacifier 10, before insertion into a toy 12 of a pacifier toy 1. With reference to FIG. 2, the toy for retaining multiple size pacifiers (pacifier toy) 1 includes the toy 12 structured to retain at least one button handle pacifier 10. The toy 12 may be of any shape or design, such as a stuffed dog toy. The toy 12 further includes a retention ring 14. The retention ring 14 is retained in an outer surface 16 of the toy 12 by sewing, sonic welding or any other suitable method. The retention ring 14 is preferably fabricated from an elastic material to facilitate insertion of the pacifier 10. The toy 12 may be filled with stuffing 15.

Each button handle pacifier 10 includes a nipple portion 18, a lip shield 20 and a retention knob 22. The nipple portion 18 extends from one side of the lip shield 20 and the retention knob 22 extends from the other side of the lip shield 20. A ring groove 24 is formed between the lip shield 20 and one end of the retention knob 22. A thickness of the retention ring 14 is sized to be receive by the ring groove 24. The other end of the retention knob 22 is preferably rounded to facilitate insertion into a knob opening 25 in the retention ring 14.

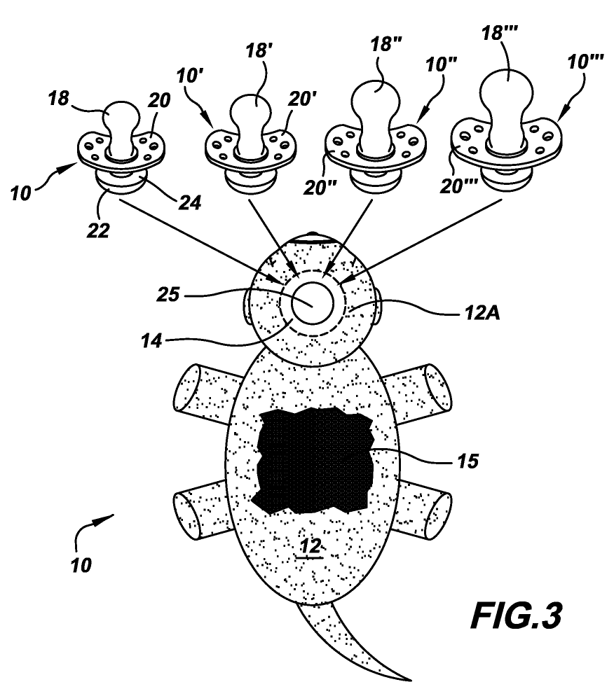

With reference to FIG. 3, a size of the nipple portion 18 and lip shield 20 are increased in size to accommodate larger oral cavities of older children. The button handle pacifier 10 is sized for a newborn; a button handle pacifier 10′ is sized for an infant; a button handle pacifier 10″ is sized for a child between the age of an infant and a toddler; and a button handle pacifier 10′″ is sized for a toddler. It is preferable for a perimeter of the retention knob 22 will remain the same regardless of the size of pacifiers 10-10′″. However, the elasticity of retention ring 14 would allow the insertion of button knobs 22 with different perimeter lengths.

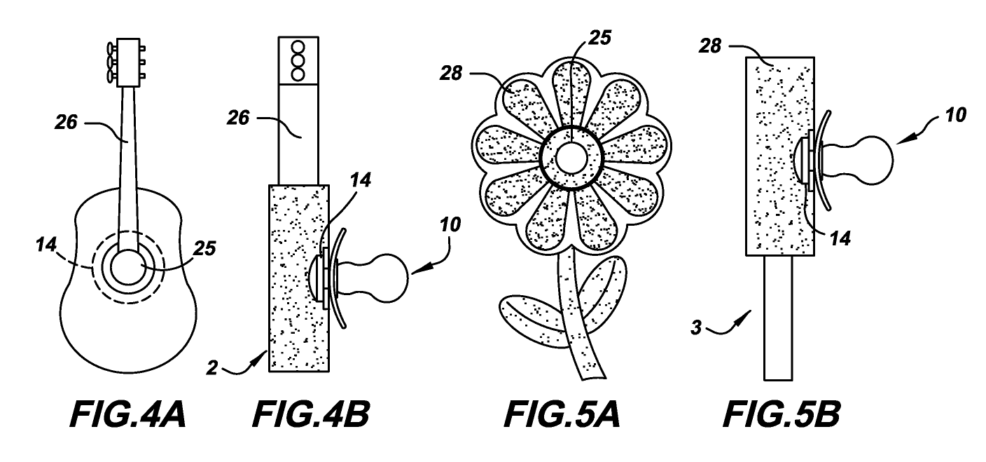

With reference to FIGS. 4a-4b, a guitar toy 26 is shown. The button handle pacifier 10 is inserted into the retention ring 14, which is secured in an outer surface of the guitar toy 26 to form a pacifier toy 2. With reference to FIGS. 5a-5b, a flower toy 28 is shown. The button handle pacifier 10 is inserted in the retention ring 14, which is secured in an outer surface of the flower toy 28 to form a pacifier toy 3.

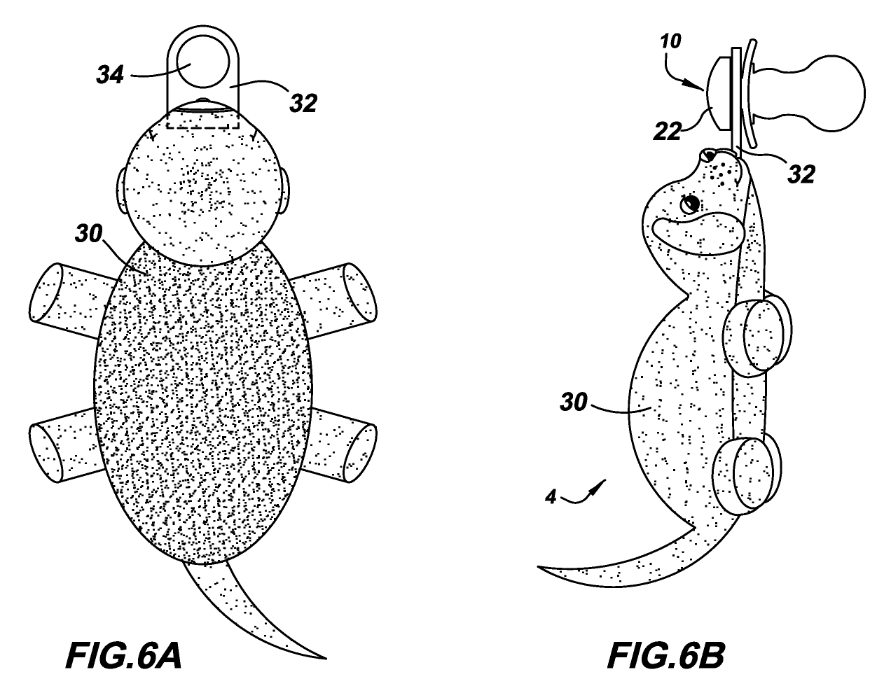

With reference to FIGS. 6a-6b, a pacifier toy 4 includes a stuffed toy 30 and a retainer ring 32. The stuffed toy 30 may be of any shape or design. The pacifier ring 32 extends outward from an outer surface of the stuffed toy 30. The retention ring 32 is retained in the stuffed toy 30 with sewing, sonic welding or any other suitable process. A knob opening 34 is formed through the pacifier ring 32 to retain the retention knob 22 of the button handle pacifier 10.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A pacifier toy in combination with a button handle pacifier comprising:
a toy having a body with an outer surface;
a retention ring being retained by an outer surface of said toy, a knob opening being formed through said retention ring; and
said button handle pacifier including a nipple portion, a lip shield and a retention knob, said nipple portion extending from one side of said lip shield and said retention knob extending from the other side of said lip shield, a ring groove being formed between said lip shield and one end of said retention knob, said retention knob being inserted into said knob opening, a thickness of said retention ring being sized to be received by said ring groove.

2. The pacifier toy in combination with a button handle pacifier of claim 1 wherein:
a rounded surface being formed on the other end of said retention knob.

3. The pacifier toy in combination with a button handle pacifier of claim 1 wherein:
said retention ring being fabricated from an elastic material.

4. The pacifier toy in combination with a button handle pacifier of claim 1 wherein:
said retention ring being sewn into said outer surface of said toy.

5. The pacifier toy in combination with a button handle pacifier of claim 1 wherein:
said retention ring extending outward from said outer surface of said toy.

6. The pacifier toy in combination with a button handle pacifier of claim 1 wherein:
said button handle pacifier including said nipple portion and said lip shield that increase in size for larger children, a size of said retention knob remaining the same regardless of the size of said nipple portion and said lip portion.

7. A pacifier toy in combination with a button handle pacifier comprising:
a toy having a body with an outer surface;
a retention ring being retained by an outer surface of said toy, a knob opening being formed through said retention ring; and
said button handle pacifier including a nipple portion, a lip shield and a retention knob, said nipple portion extending from one side of said lip shield and said retention knob extending from the other side of said lip shield, a ring groove being formed between said lip shield and one end of said retention knob, a rounded surface being formed on the other end of said retention knob, said retention knob being inserted into said knob opening, a thickness of said retention ring being sized to be received by said ring groove.

8. The pacifier toy in combination with a button handle pacifier of claim 7 wherein:
said retention ring being fabricated from an elastic material.

9. The pacifier toy in combination with a button handle pacifier of claim 7 wherein:
said retention ring being sewn into said outer surface of said toy.

10. The pacifier toy in combination with a button handle pacifier of claim 7 wherein:
said retention ring extending outward from said outer surface of said toy.

11. The pacifier toy in combination with a button handle pacifier of claim 7 wherein:
said button handle pacifier including said nipple portion and said lip shield that increase in size for larger children, a size of said retention knob remaining the same regardless of the size of said nipple portion and said lip portion.

12. A pacifier toy in combination with a button handle pacifier comprising:
a toy having a body with an outer surface;
a retention ring being retained by an outer surface of said toy, a knob opening being formed through said retention ring, said retention ring being fabricated from an elastic material; and
said button handle pacifier including a nipple portion, a lip shield and a retention knob, said nipple portion extending from one side of said lip shield and said retention knob extending from the other side of said lip shield, a ring groove being formed between said lip shield and one end of said retention knob, said retention knob being inserted into said knob opening, a thickness of said retention ring being sized to be received by said ring groove.

13. The pacifier toy in combination with a button handle pacifier of claim 12 wherein:
a rounded surface being formed on the other end of said retention knob.

14. The pacifier toy in combination with a button handle pacifier of claim 12 wherein:
said retention ring being sewn into said outer surface of said toy.

15. The pacifier toy in combination with a button handle pacifier of claim 12 wherein:
said retention ring extending outward from said outer surface of said toy.

16. The pacifier toy in combination with a button handle pacifier of claim 12 wherein:
said button handle pacifier including said nipple portion and said lip shield that increase in size for larger children, a size of said retention knob remaining the same regardless of the size of said nipple portion and said lip portion.
